(19) United States
(12) Patent Application Publication
(10) Pub. No.: US 2008/0290778 A1
(43) Pub. Date: Nov. 27, 2008

(54) Fluorescent Lamp, Back Light Unit, And Method Of Manufacturing The Fluorescent Lamp

(76) Inventors: Hirofumi Yamashita, Osaka (JP); Nozomu Hashimoto, Osaka (JP); Yusuke Mori, Kyoto (JP); Hisashi Dejima, Kyoto (JP); Tatsuo Maeda, Osaka (JP)

Correspondence Address: SNELL & WILMER L.L.P. (Matsushita), 600 ANTON BOULEVARD, SUITE 1400, COSTA MESA, CA, 92626, US

(21) Appl. No.: 11/628,915

(22) PCT Filed: May 30, 2005
(86) PCT No.: PCT/JP2005/009896

§ 371 Date: Jan. 10, 2008

(30) Foreign Application Priority Data
Jun. 30, 2004 (JP) 2004-194537

(51) Int. Cl. H01J 1/62; H01J 9/02

(52) U.S. Cl. 313/486; 445/26

(57) ABSTRACT

A fluorescent lamp including a curved glass bulb that has a layer including a phosphor layer on an inner surface, mercury and a rare gas enclosed inside, and a pair of electrodes at both ends, and when a tube inner diameter (mm) of the glass bulb is plotted on a horizontal axis of an orthogonal coordinate system and a total amount of CO₂ and CO (mol %) contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments AB, BC, CD, and DA that connect a point A (1.5 mm, 0.008 mol %), a point B (4.0 mm, 0.0005 mol %), a point C (4.0 mm, 0 mol %), and a point D (1.5 mm, 0 mol %) in the stated order. As a result, a fluorescent lamp that has no illumination failure caused by snaking can be obtained even though the fluorescent lamp is in a curved shape.

### TECHNICAL FIELD

The present invention mainly relates to a cold-cathode fluorescent lamp, a backlight unit used in liquid crystal display televisions whose main light source is formed by the cold-cathode fluorescent lamp, and a manufacturing method of the cold-cathode fluorescent lamp.

### BACKGROUND ART

As one problem caused mainly by a cold-cathode fluorescent lamp, there is a phenomenon called “snaking” in which a positive column snakes through the lamp while the lamp is turned on. If an impure gas such as CO₂ (carbon dioxide), CO (carbon monoxide) or the like exists between a pair of electrodes in a glass bulb, snaking occurs because a discharge snakes so as to avoid the impure gas.

Snaking causes the fluorescent lamp to flicker. If the flicker worsens, an illumination failure occurs. Therefore, when sealing the glass bulb, the glass bulb is sufficiently evacuated so that no impure gas remains in the glass bulb. After this, a rare gas is enclosed in the glass bulb.

Conventionally, a getter is provided in the glass bulb to eliminate the impure gas from the glass bulb after the rare gas is enclosed. The getter is a chemical substance that traps the impure gas. For example, a patent document 1 discloses a technique of providing a getter near an electrode, and a patent document 2 discloses a technique of fixing a getter on a surface of an electrode.

### Patent Document 1: Japanese Published Patent Application No. 2003-197147

Patent Document 2: Japanese Published Patent Application No. H06-290741

### DISCLOSURE OF THE INVENTION

### Problems the Invention is Going to Solve

A cold-cathode fluorescent lamp in a shape of a straight tube is conventionally used as a backlight unit in liquid crystal display televisions. In recent years, in addition to a straight cold-cathode fluorescent lamp, a curved cold-cathode fluorescent lamp made by bending a straight cold-cathode fluorescent lamp into a shape of U begins to be used as a backlight unit in liquid crystal display televisions.

However, in a case of the curved cold-cathode fluorescent lamp, an illumination failure caused by snaking occurs even if the glass bulb is evacuated or the getter is provided in the same way as a straight cold-cathode fluorescent lamp. Therefore, it is urgent to investigate the cause of snaking specific to the curved cold-cathode fluorescent lamp and obtain a cold-cathode fluorescent lamp that has no illumination failure caused by snaking even though the cold-cathode fluorescent lamp is in the curved shape.

In view of this, a main object of the present invention is to provide a fluorescent lamp that has no illumination failure caused by snaking even though the fluorescent lamp is in the curved shape and a manufacturing method of the fluorescent lamp. Another object of the present invention is to provide a backlight unit that uses the fluorescent lamp and has no flicker caused by snaking.

### Means of Solving the Problems

The above-mentioned objects can be achieved by a fluorescent lamp including a curved glass bulb that has a layer including a phosphor layer on an inner surface, mercury and a rare gas enclosed inside, and a pair of electrodes at both ends, characterized in that: a gas pressure in the glass bulb is in a range of 4.0 kPa to 13.4 kPa inclusive; and when a tube inner diameter, expressed in mm, of the glass bulb is plotted on a horizontal axis of an orthogonal coordinate system and a total amount of CO₂ and CO, expressed in mol %, contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments AB, BC, CD, and DA that connect a point A (1.5 mm, 0.008 mol %), a point B (4.0 mm, 0.0005 mol %), a point C (4.0 mm, 0 mol %) and a point D (1.5 mm, 0 mol %) in the stated order.

Note that the total amount (mol %) of CO₂ and CO contained in gas present inside the glass bulb is a total sum of a total amount (mol %) of CO₂ and CO contained in the gas and a total amount (mol %) of CO₂ and CO contained in mercury in a fluorescent lamp as an end product after an aging process.

The above-mentioned objects can also be achieved by a fluorescent lamp including a curved glass bulb that has a layer including a phosphor layer on an inner surface, mercury and a rare gas enclosed inside, and a pair of electrodes at both ends, characterized in that: a gas pressure in the glass bulb is in a range of 4.0 kPa to 13.4 kPa inclusive; and when a tube inner diameter, expressed in mm, of the glass bulb is plotted on a horizontal axis of an orthogonal coordinate system and a total amount of CO₂ and CO, expressed in mol %, contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments EF, FG, GH, and HE that connect a point E (2.0 mm, 0.005 mol %), a point F (3.0 mm, 0.0015 mol %), a point G (3.0 mm, 0 mol %), and a point H (2.0 mm, 0 mol %) in the stated order.

Moreover, in another specific phase of the fluorescent lamp of the present invention, the layer including the phosphor layer further includes a protection film containing a low-melting glass.

Furthermore, in other specific phase of the fluorescent lamp of the present invention, a getter for trapping CO₂ and CO is provided in the glass bulb.

A backlight unit includes the fluorescent lamp as a light source.

A manufacturing method of a curved fluorescent lamp, which forms a phosphor layer on an inner surface of a straight glass bulb, attaches a pair of electrodes to both ends of the glass bulb, encloses mercury and a rare gas in the glass bulb, and then bends the straight glass bulb into a curved shape, characterized in that: after the bending, an aging process of eliminating CO₂ and CO in the glass bulb is performed by passing a current exceeding a current value for steady lighting through the pair of electrodes.

### EFFECTS OF THE INVENTION

The fluorescent lamp of the present invention fulfills such a following requirement. When a tube inner diameter (mm) of the glass bulb is plotted on a horizontal axis of an orthogonal coordinate system and a total amount of CO₂ and CO (mol %) contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments AB, BC, CD, and DA that connect a point A (1.5 mm, 0.008 mol %), a point B (4.0 mm, 0.0005 mol %), a point C (4.0 mm, 0 mol %), and a point D (1.5 mm, 0 mol %) in the stated order. If this requirement is fulfilled, the fluorescent lamp has no illumination failure such as a flicker caused by snaking because the total amount of CO₂ and CO can be reduced to an amount that does not disturb discharging.

The fluorescent lamp of the present invention also fulfills a following requirement. When a tube inner diameter (mm) of the glass bulb is plotted on a horizontal axis of an orthogonal coordinate system and a total amount of CO₂ and CO (mol %) contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments EF, FG, GH, and HE that connect a point E (2.0 mm, 0.005 mol %), a point F (3.0 mm, 0.0015 mol %), a point G (3.0 mm, 0 mol %), and a point H (2.0 mm, 0 mol %) in the stated order. A fluorescent lamp, that fulfills this requirement, has a high industrial productivity and has no illumination failure caused by snaking.

In general, if the protection film containing the low-melting glass is formed, CO₂ and CO are likely to occur in the glass bulb. However, the fluorescent lamp of the present invention, that fulfills the above-mentioned requirement, has no illumination failure caused by snaking.

Moreover, if the getter for trapping CO₂ and CO is provided in the glass bulb in the fluorescent lamp of the present invention, the fluorescent lamp has much less illumination failure caused by snaking because the impure gas occurred after the aging treatment can be trapped.

Since the backlight unit of the present invention includes the fluorescent lamp mentioned above, the backlight unit has no illumination failure such as a flicker. Therefore, if the backlight unit is used in liquid crystal display televisions, for example, the liquid crystal display televisions cause less eyestrain of viewers and have a high level of visibility.

A manufacturing method of a fluorescent lamp of the present invention is forming a phosphor layer on an inner surface of a straight glass bulb, attaching a pair of electrodes to both ends of the glass bulb, enclosing mercury and a rare gas in the glass bulb, and then bending the straight glass bulb into a curved shape. Then, an aging process of eliminating CO₂ and CO in the glass bulb is performed by passing a current exceeding a current value for steady lighting through the pair of electrodes after the bending. Accordingly, the total amount of CO₂ and CO in the glass bulb can be reduced to an amount that suppresses snaking, and the fluorescent lamp that causes less snaking can be manufactured.

### BRIEF DESCRIPTION OF THE DRAWINGS

FIG. 1 is a partially broken perspective view of a backlight unit of an embodiment of the present invention.

FIG. 2 is a partially broken plan view of a fluorescent lamp of an embodiment of the present invention.

FIG. 3 is a plan view showing a fluorescent lamp of a modification.

FIG. 4 is a plan view showing a fluorescent lamp of a modification.

FIG. 5 is a flowchart describing a manufacturing process of a fluorescent lamp of the present invention.

FIG. 6 shows an effect of a heating treatment on an impure gas amount and snaking.

FIG. 7 shows a relation between an impure gas amount and snaking of a fluorescent lamp whose tube inner diameter is 3.0 mm.

FIG. 8 shows a relation between an impure gas amount and snaking of a fluorescent lamp whose tube inner diameter is 2.0 mm.

FIG. 9 shows an effect of a tube inner diameter and an impure gas amount on snaking.

FIG. 10 is a partially broken plan view of one end of a cold-cathode fluorescent lamp of a first modification, and an enlarged view showing a part of a cross section.

FIG. 11 is a partially broken plan view of a cold cathode fluorescent lamp of a second modification.

### DESCRIPTION OF REFERENCE NUMERALS

1: backlight unit
10, 32, 35, 50, 60: fluorescent lamp
11, 31, 34, 51, 61: glass bulb
12a, 12b, 52, 62a, 62b: end of glass bulb
13, 53, 63: electrode
54, 64: protection film
15, 55, 65: phosphor layer

### BEST MODE FOR CARRYING OUT THE INVENTION

The following describes a fluorescent lamp and a backlight unit according to an embodiment of the present invention, with reference to the attached drawings.

### <Description of the Backlight Unit>

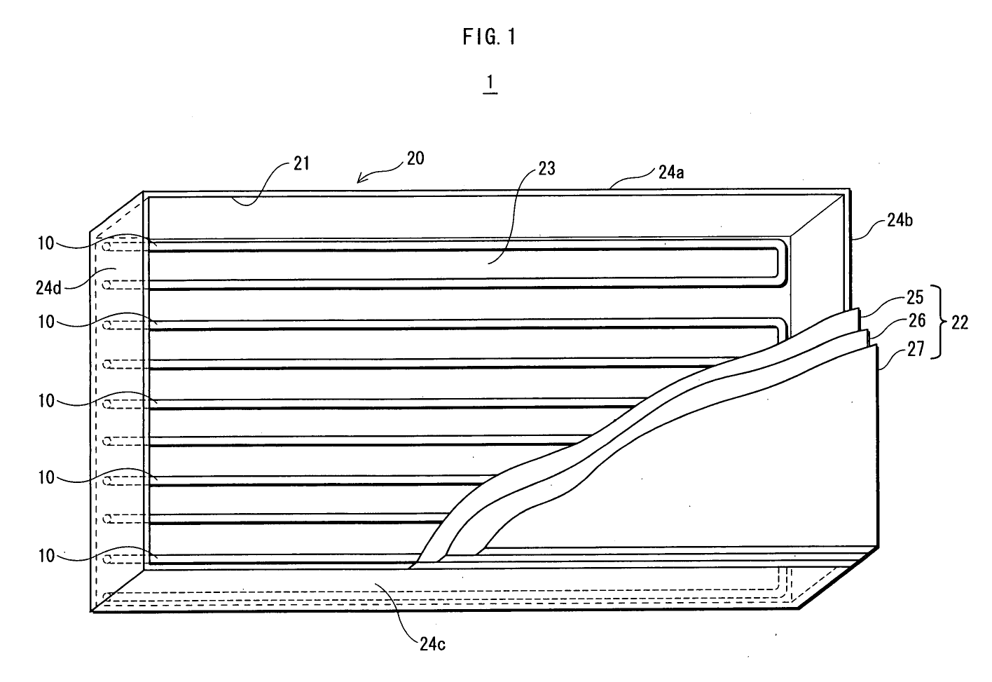

FIG. 1 is a partially broken perspective view of a backlight unit of the embodiment of the present invention. The construction of the backlight unit is basically similar to a construction of a backlight unit produced using a conventional technology.

As shown in FIG. 1, a backlight unit 1 includes a plurality of cold-cathode fluorescent lamps 10 in a shape of Japanese character [symbol] that are arranged at intervals, a box 20 that houses the fluorescent lamps 10, and a front panel 22 for covering an opening 21 of the box 20.

The box 20 is made of a resin such as polyethylene terephthalate (PET) resin. The box 20 is composed of a bottom plate 23 and four side plates 24a, 24b, 24c, and 24d that stand along the edges of the bottom plate 23. The bottom plate 23 functions as a reflection plate that reflects light, which is emitted from the fluorescent lamps 10 toward the bottom plate 23, to the opening 21.

The front panel 22 is a member that diffuses the light from the fluorescent lamps 10 to extract the light as parallel light (in a normal direction of the front panel 22), and is composed of a diffusion plate 25, a diffusion sheet 26, and a lens sheet 27. Each of the diffusion plate 25, the diffusion sheet 26, and the lens sheet 27 is made of a resin such as polycarbonate (PC) resin or acrylic resin.

### <Description of the Fluorescent Lamps>

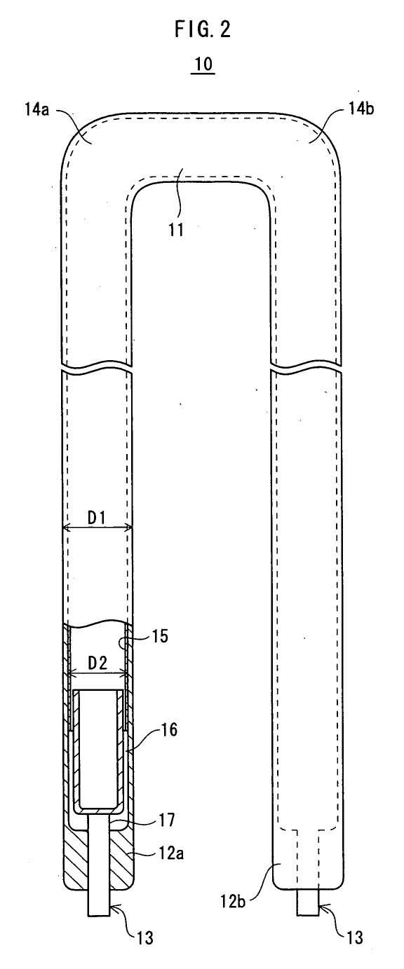

FIG. 2 is a partially broken plan view of a fluorescent lamp of the embodiment of the present invention. As shown in FIG. 2, a fluorescent lamp 10 includes a glass bulb 11 that is made of hard glass and a pair of electrodes 13 attached to both ends 12a and 12b of the glass bulb 11.

The glass bulb 11 is in a shape of Japanese character [symbol] and has two bending portions 14a and 14b that are each bent approximately at a right angle. The glass bulb has a tube outer diameter (D1) of 3 mm and a tube inner diameter (D2) of 2 mm. A phosphor layer 15 (tri-band phosphor, for example) is formed on an inner surface of the glass bulb 11. Also, mercury and a rare gas are enclosed in the glass bulb 11.

Each of the electrodes 13 is composed of an electrode body 16 that is in a shape of a cylinder with a bottom and an electrode bar 17 that is attached to the bottom of the electrode body 16. Each of the electrodes 13 is hermetically connected to the respective ends 12a and 12b of the glass bulb 11 at the electrode bar 17.

Up to now, the fluorescent lamp of the present invention has been described through the embodiment. However, the present invention is not limited to such embodiment.

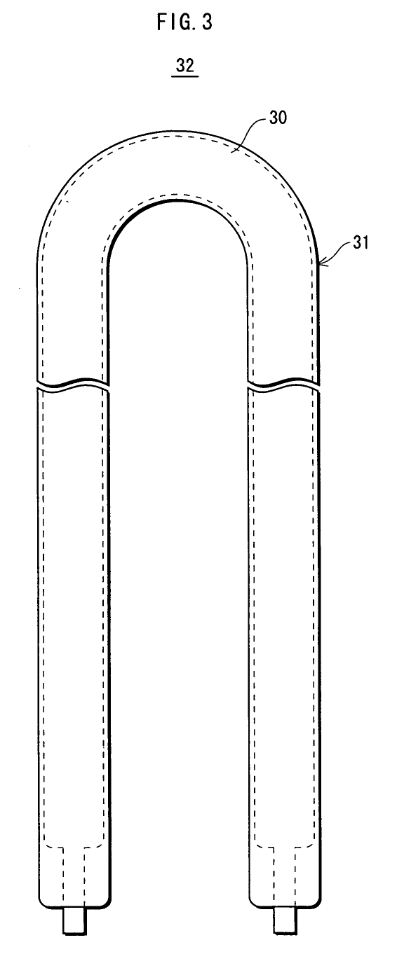

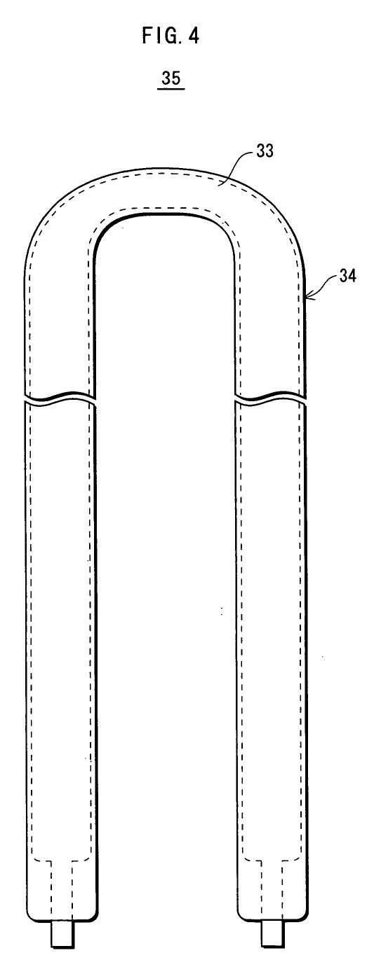

For example, the glass bulb is not limited to the shape of [symbol] , and can take other curved shapes (the curved shape in the present invention means a non-straight shape). More specifically, the following may be included: a U-shaped fluorescent lamp 32 including a glass bulb 31 that has one bending portion 30 as shown in FIG. 3; and a U-shaped fluorescent lamp 35 including a glass bulb 34 whose bending portion 33 is flattened or becomes thin by being dented as shown in FIG. 4. Note that if a part of a glass bulb is dented, an inner diameter before being dented is defined as the tube inner diameter (D2).

### <Manufacturing Method for the Fluorescent Lamp>

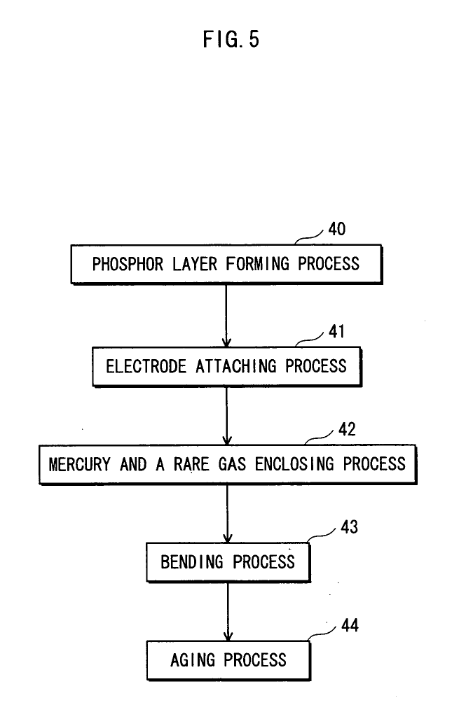

The following describes a manufacturing method for the fluorescent lamp 10 of the embodiment. FIG. 5 is a flowchart describing a manufacturing process of the fluorescent lamp. As shown in FIG. 5, the fluorescent lamp 10 is manufactured by executing a phosphor layer forming process 40, an electrode attaching process 41, a mercury and rare gas enclosing process 42, a bending process 43, and an aging process 44 in sequence.

In the phosphor layer forming process 40, the phosphor layer 15 is formed on the inner surface of a straight glass bulb. More specifically, the phosphor layer 15 is formed by pouring phosphor slurry into the straight glass bulb (not illustrated) to apply the phosphor slurry to the inner surface of the straight glass bulb, and then drying the phosphor slurry by a heating furnace such as electricity, gas or the like.

In the electrode attaching process 41, the pair of electrodes 13 are attached to both ends 12a and 12b of the straight glass bulb. More specifically, one electrode 13 is sealed to one end 12a of the straight glass bulb, and the other electrode 13 is arranged at the other end 12b of the straight glass bulb.

In the mercury and rare gas enclosing process 42, mercury and a rare gas are enclosed in the straight glass bulb. More specifically, the straight glass bulb is heated to a predetermined temperature (about 400° C., for example). In this state, CO₂, CO, moisture and the like in the glass bulb are exhausted from the other end 12b at which the other electrode 13 is arranged. At the same time as or after this exhaustion, the mercury and the rare gas are put into the glass bulb, and then the other end 12b is sealed.

In the bending process 43, the curved glass bulb 11 is made by bending the straight glass bulb. More specifically, two parts (that become the bending portions 14a and 14b after the bending process) near the center of the straight glass bulb are heated to about 700° C. to soften the hard glass. The softened parts are then bent to be formed in the shape of Japanese character [symbol] by a bending apparatus (not illustrated). Note that when the glass bulb is formed in the shape of character U, whole of the bending portion 30 is heated to about 700° C. to be bent in the same manner as this. As a result, a fluorescent lamp whose appearance is approximately same as an end product (a fluorescent lamp in an unfinished state) is completed.

In the aging process 44, CO₂ and CO in the curved glass bulb 11 are eliminated by an aging treatment to stabilize the lamp characteristic and obtain the fluorescent lamp 10 as the end product.

More specifically, the aging treatment is conducted by performing a blinking operation two or more times. In the blinking operation, a current (which exceeds a current value for steady lighting, for example) is passed through each of the pair of electrodes 13 to create a turn-on state of the fluorescent lamp, then the current is stopped to create a turn-off state. This blinking operation has following effects. By turning on the fluorescent lamp, ion bombardment occurs due to an increase in temperature and a discharge, which enables CO₂ and CO contained in the phosphor layer 15, the pair of electrodes 13, mercury and the like to be released inside the glass bulb 11. Further, by turning off the fluorescent lamp, CO₂ and CO can be eliminated from the glass bulb 11 due to a reaction of the released CO₂ and CO chemically with mercury in an active state, or due to physical adsorption of CO₂ and CO by the phosphor layer 15.

This prevents a start-up failure and the occurrence of snaking of the fluorescent lamp 10 as the end product. Since the temperature of the fluorescent lamp 10 as the end product does not increase equal to or higher than 300° C. in a normal turn-on state, there is no possibility that CO₂ and CO which have been eliminated by being chemically reacted with mercury or physically adsorbed to the phosphor layer 15 will be gasified (emitted) again. Accordingly, a start-up failure and snaking can be prevented.

In the aging treatment mentioned above, it is preferable to turn on the fluorescent lamp 10 so that a surface temperature of a part between the pair of electrodes 13 of the glass bulb 11, i.e. a surface temperature within an area of a central part of the glass bulb 11 excluding the both ends 12a and 12b, is equal to or higher than 80° C. This shortens a time for the aging treatment because the emission of CO₂ and CO when the fluorescent lamp is turned on and the elimination of CO₂ and CO when the fluorescent lamp is turned off are accelerated.

Note that the above surface temperature is not limited to be equal to or higher than 80° C. By making the surface temperature higher than an ambient temperature, CO₂ and CO can be emitted from the phosphor layer 15, the pair of electrodes 13 and the like. After this, by decreasing the temperature by turning off the fluorescent lamp, the emitted CO₂ and CO can be reacted with mercury or adsorbed to the phosphor layer 15. The temperature increasing characteristic of the fluorescent lamp 10 is different depending on an interval between the pair of electrodes 13, a power feeding condition to the pair of electrodes 13 (a current value and a voltage value), the outer diameter of the glass bulb 11, and the like. However, the surface temperature can be controlled by adjusting the turn-on time of the fluorescent lamp properly.

In the aging treatment mentioned above, it is preferable that the turn-on state of the blinking operation continues for equal to or longer than 4 minutes. This reliably increases the temperature of the fluorescent lamp 10, with it being possible to repeat the emission and elimination of CO₂ and CO effectively. On the other hand, it is preferable that the turn-off state of the blinking operation is maintained until the temperature of the fluorescent lamp 10, which is increased by the turn-on state, decreases to a temperature level at which CO₂ and Co react chemically with mercury.

### <Experiment>

### 1. Cause of Snaking

The inventors found that snaking in a curved fluorescent lamp is caused by the heating treatment in the bending process 43.

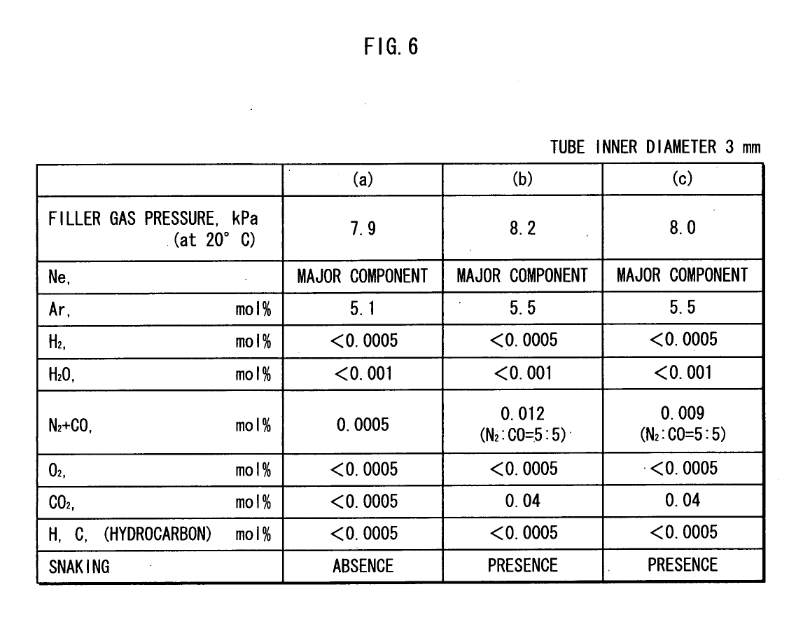

FIG. 6 shows an effect of the heating treatment on an impure gas amount and snaking. In FIG. 6, (a) indicates a fluorescent lamp for which the heating treatment was not executed, and (b) and (c) indicate fluorescent lamps for which the heating treatment was executed.

A fluorescent lamp whose tube inner diameter is 3.0 mm was used in the experiment. A straight fluorescent lamp prior to the bending process 43 was used as the fluorescent lamp for which the heating treatment was not executed, and straight fluorescent lamps prior to the bending process 43, which had been heated to 300° C., were used as the fluorescent lamps for which the heating treatment was executed.

The measurement of the impure gas amount was performed by measuring the amount of CO₂ and CO contained in the enclosed gas in the glass bulb by a well-known mass spectrometry using a quadrupole mass spectrometer (Patent Document: Japanese Published Patent Application No. 2001-349870). Also, the absence or presence of snaking was judged by a visual observation of a flicker and the like of the fluorescent lamp.

With regard to the fluorescent lamp (a) for which the heating treatment was not executed, the total amount of CO₂ and CO, i.e. the impure gas amount, was not more than 0.001 mol % (CO₂ was 0.0005 mol %, and CO was not more than 0.0005 mol %). On the other hand, with regard to the fluorescent lamps (b) and (c) for which the heating treatment was executed, the impure gas amount of the fluorescent lamp (b) was about 0.046 mol % (CO₂ was 0.04 mol %, and CO was not more than 0.006 mol %) and the impure gas amount of the fluorescent lamp (c) was about 0.045 mol % (CO₂ was 0.04 mol %, and CO was not more than 0.0045 mol %).

From the result mentioned above, it was confirmed that the impure gas amount increases because of the heating treatment. Also, it is predicted that the impure gas amount is increased by the heating treatment because the impure gas adsorbed to the phosphor layer 15, the pair of electrodes 13 and the like is emitted from the phosphor layer 15, the pair of electrodes 13 and the like by the heating treatment.

Also, the fluorescent lamp (a) whose impure gas amount was not more than 0.001 mol % did not have snaking. However, the fluorescent lamp (b) whose impure gas amount was about 0.046 mol % and the fluorescent lamp (c) whose impure gas amount was about 0.045 mol % had snaking.

### 2. Relation Between Impure Gas Amount and Snaking

In order to define an impure gas amount that suppresses snaking, various fluorescent lamps with different impure gas amounts were prepared. The presence or absence of snaking in the various fluorescent lamps was evaluated, and the effect of the impure gas amount on snaking was investigated.

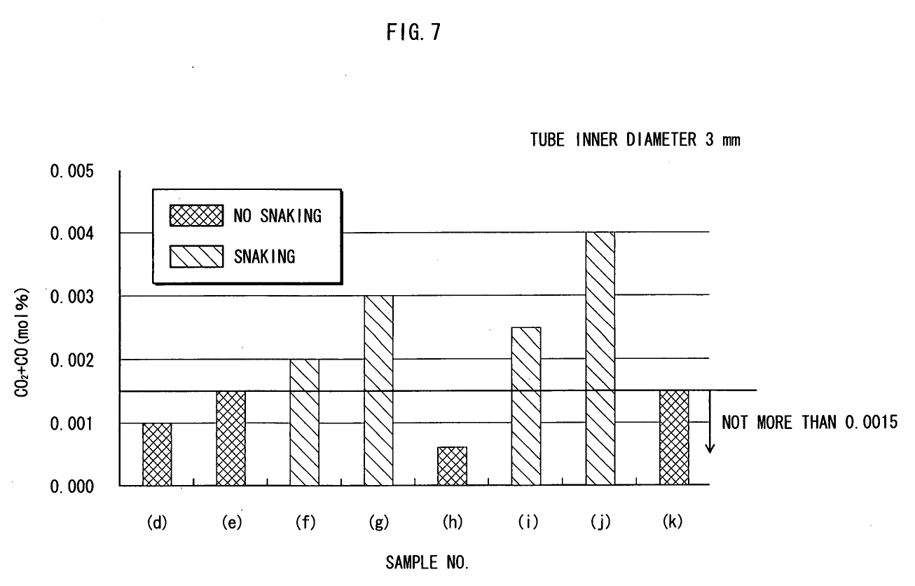

FIG. 7 shows a relation between an impure gas amount and snaking of a fluorescent lamp whose tube inner diameter is 3.0 mm. As shown in FIG. 7, fluorescent lamps (d), (e), (h), and (k) with an impure gas amount of not more than 0.0015 mol % did not have snaking. On the other hand, fluorescent lamps (f), (g), (i), and (j) with an impure gas amount of more than 0.0015 mol % had snaking. From this result, it can be confirmed that, in the case of a fluorescent lamp whose tube inner diameter is 3.0 mm, snaking does not occur if the impure gas amount is not more than 0.0015 mol %.

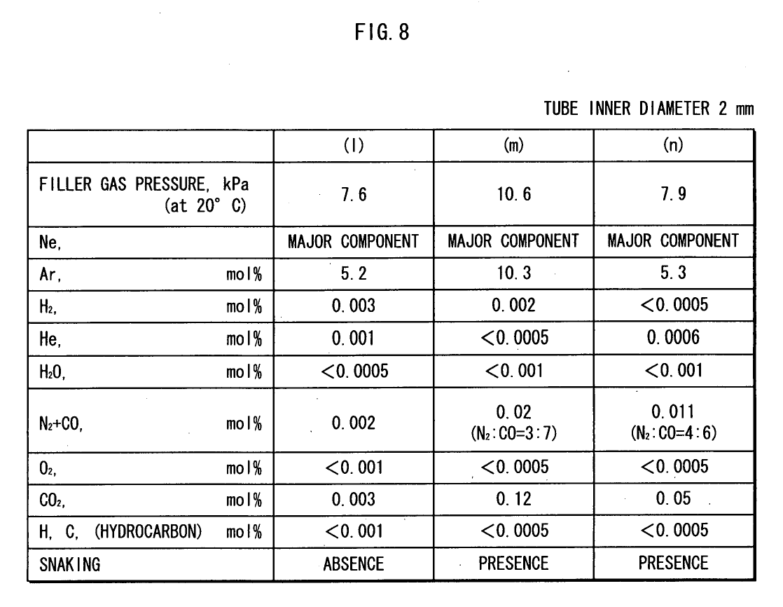

FIG. 8 shows a relation between an impure gas amount and snaking of a fluorescent lamp whose tube inner diameter is 2.0 mm. As shown in FIG. 8, a fluorescent lamp (l) with an impure gas amount of not more than 0.005 mol % (CO₂ was 0.003 mol %, and CO was not more than 0.002 mol %) did not have snaking. On the other hand, a fluorescent lamp (m) with an impure gas amount of 0.134 mol % (CO₂ was 0.12 mol %, and CO was 0.014 mol %) and a fluorescent lamp (n) with an impure gas amount of 0.0566 mol % (CO₂ was 0.05 mol %, and CO was not more than 0.0066 mol %) had snaking. From this result, it can be confirmed that, in the case of a fluorescent lamp whose tube inner diameter is 2.0 mm, snaking does not occur if the impure gas amount is not more than 0.005 mol %.

Moreover, as for fluorescent lamps with different sizes of a tube inner diameter from that of above-mentioned lamps, the same experiment was conducted to investigate an impure gas amount that suppresses snaking. For example, in the case of a fluorescent lamp with a tube inner diameter of 1.5 mm, if the impure gas amount was not more than 0.008 mol %, the fluorescent lamp did not have snaking. Also, in the case of a fluorescent lamp with a tube inner diameter of 4.0 mm, if the impure gas amount was not more than 0.0005 mol %, the fluorescent lamp did not have snaking.

Note that in the case of a fluorescent lamp with a tube inner diameter of less than 1.5 mm, if an impure gas is contained in the fluorescent lamp, the tube voltage rises and the fluorescent lamp becomes unlightable even before snaking occurs. Also, in the case of a fluorescent lamp with a tube inner diameter of more than 4.0 mm, snaking is caused even by a small amount of an impure gas that cannot be determined with accuracy by the mass spectrometry. Therefore, the experiment was conducted with regard to fluorescent lamps in a range of 1.5 mm to 4.0 mm inclusive in a tube inner diameter.

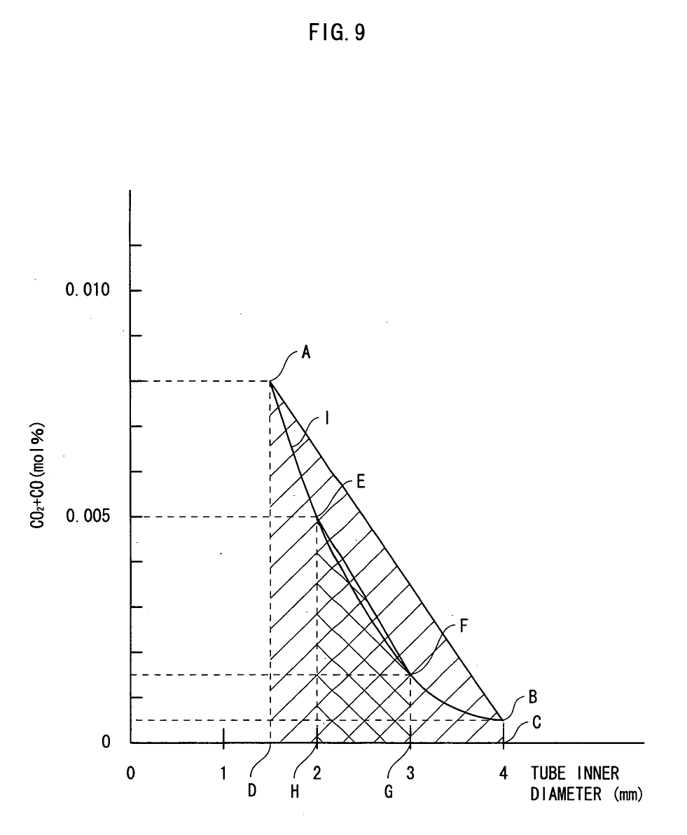

FIG. 9 shows an effect of a tube inner diameter and an impure gas amount on snaking. In a graph of FIG. 9, an inner diameter (mm) of a glass bulb is plotted on a horizontal axis and an impure gas amount (mol %) is plotted on a vertical axis. A curved line I of FIG. 9 indicates a condition under which it is highly unlikely that snaking occurs. If the impure gas amount is less than the condition shown on the curved line I, snaking can be suppressed effectively.

Based on the graph of FIG. 9, the condition under which snaking hardly occurs was determined. The graph shows that, in the case of a fluorescent lamp with a tube inner diameter of 1.5 mm, if the impure gas amount was not more than 0.008 mol %, snaking was suppressed effectively. Also, in the case of a fluorescent lamp with a tube inner diameter of 4.0 mm, if the impure gas amount was not more than 0.0005 mol %, snaking was suppressed effectively. Therefore, in order to obtain a fluorescent lamp that causes less snaking, the fluorescent lamp of the present invention is required to fulfill such a requirement that the tube inner diameter and the total amount of CO₂ and CO are in a predetermined area or on a boundary thereof, the predetermined area being bounded by line segments AB, BC, CD, and DA that connect a point A (1.5 mm, 0.008 mol %), a point B (4.0 mm, 0.0005 mol %), a point C (4.0 mm, 0 mol %), and a point D (1.5 mm, 0 mol %) in a graph of FIG. 9 in the stated order.

If the tube inner diameter of the fluorescent lamp is less than 2 mm, it becomes difficult to perform the bending process and a fabrication yield decreases. If the tube inner diameter is more than 3 mm, the glass amount for manufacturing the glass bulb increases and a cost of the glass bulb becomes higher. Therefore, the tube inner diameter of the glass bulb is required to be in a range of 2 mm to 3 mm inclusive to manufacture a fluorescent lamp that has a high industrial productivity. Accordingly, in order to obtain a fluorescent lamp that has the high industrial productivity and suppresses snaking, the fluorescent lamp of the present invention fulfills such a requirement that the tube inner diameter and the total amount of CO₂ and CO are in a predetermined area or on a boundary thereof, the predetermined area being bounded by line segments EF, FG, GH, and HE that connect a point E (2.0 mm, 0.005 mol %), a point F (3.0 mm, 0.0015 mol %), a point G (3.0 mm, 0 mol %), and a point H (2.0 mm, 0 mol %) in a graph of FIG. 9 in the stated order.

Note that snaking is more likely to occur as a gas pressure in the glass bulb becomes higher. Therefore, when the impure gas amount is defined, the gas pressure of the enclosed gas in the glass bulb is required to be defined. If the gas pressure is less than 4.0 kPa, the pair of electrodes 13 cannot be endured until a rating life. Also, if the gas pressure is more than 13.4 kPa, the brightness of the fluorescent lamp is not high because the gas pressure is too high. Accordingly, the experiment mentioned above was conducted in a range of 4.0 kPa to 13.4 kPa inclusive in the gas pressure. Moreover, it is preferable that the gas pressure is in a range of 5.3 kPa to 10.7 kPa inclusive to achieve the stable lamp characteristic as the product. However, it goes without saying that, in a range of 5.3 kPa to 10.7 kPa inclusive, snaking can be suppressed effectively by the impure gas amount defined above.

Up to now, the fluorescent lamp and the backlight unit of the present invention have been described through the embodiment. However, the present invention is not limited to such embodiment.

### <First Modification>

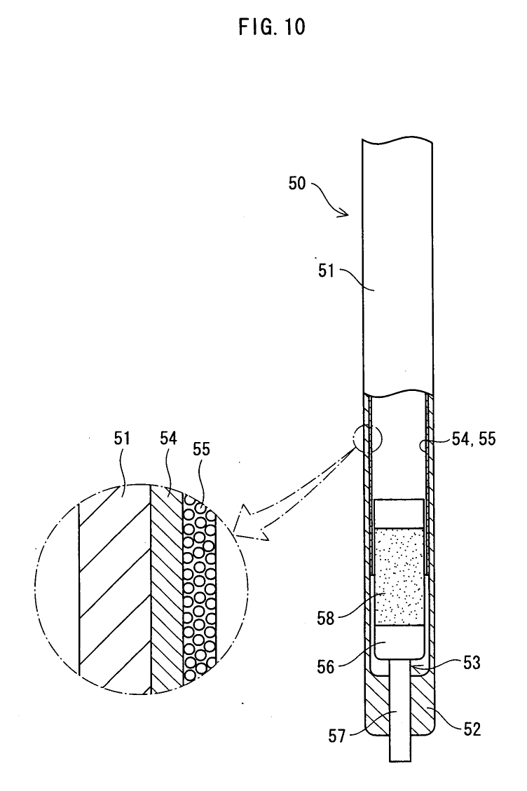

FIG. 10 is a partially broken plan view of one end of a cold-cathode fluorescent lamp of a first modification, and an enlarged view showing a part of a cross section. As shown in FIG. 10, a fluorescent lamp 50 of the first modification includes a glass bulb 51 and a pair of electrodes 53 attached to both ends 52 of the glass bulb 51.

A protection film 54 and a phosphor layer 55 (tri-band phosphor, for example) are laminated on an inner surface of the glass bulb 51 in sequence. Also, mercury and a rare gas are enclosed in the glass bulb 51.

Each of the electrodes 53 is composed of an electrode body 56 that is in the shape of a cylinder with a bottom and an electrode bar 57 that is attached to the bottom of the electrode body 56. Each of the electrodes 53 is hermetically connected to the respective ends 52 of the glass bulb 51 at the electrode bar 57. Also, a getter 58 is fixed on a part of an outer surface of the electrode body 56. The getter 58 is composed of an alloy of zirconium and aluminum, for example.

Generally, a binder including a low-melting glass, which is same as that for the phosphor layer 55, is used for the protection film 54. The low-melting glass includes CBBP (constituted by calcium oxide [CaO], barium oxide [BaO], boron oxide [B₂O₃], and phosphorus oxide [P₂O₅]), CBB (constituted by CaO, BaO, and B₂O₃.), CBP (constituted by CaO, B₂O₃ and P₂O₅) and the like.

The low-melting glass contains a relatively large amount of an impure gas because the low-melting glass has strong impure gas adsorption. As a result, a large amount of the impure gas is emitted by the heating treatment in the bending process 43. Therefore, the construction of the present invention is more effective for the fluorescent lamp 50 in which the protection film 54 and the phosphor layer 55, both of which contain the low-melting glass, are formed.

### <Second Modification>

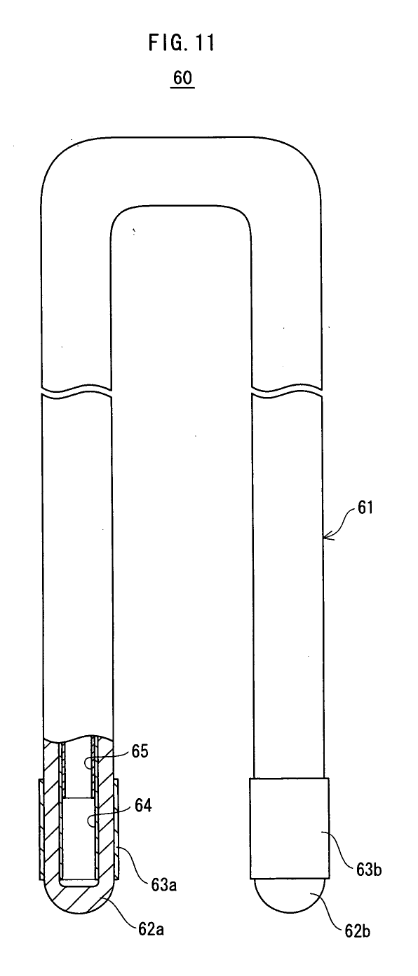

FIG. 11 is a partially broken plan view of a cold cathode fluorescent lamp of a second modification. As shown in FIG. 11, a fluorescent lamp 60 of the second modification includes a glass bulb 61 and a pair of external electrodes 63a and 63b attached to outer circumference surfaces of both ends 62a and 62b of the glass bulb 61.

Each of the external electrodes 63 is metal foil that is twisted around the outer circumference surface of the glass bulb 61 in the shape of a cylinder, and is pasted on the glass bulb 61 with a conductive adhesive (not illustrated). The metal foil is made of metal foil of aluminum, and the conductive adhesive is made by mixing a fine particle of a metal with silicon resin, fluorocarbon resin, polyimide resin, epoxy resin or the like, for example.

Note that each of the external electrodes 63 is not limited to the above construction, and can be formed by applying a silver paste to an entire circumference surface of a part of the glass bulb 61 in which the electrode is formed. Also, the shape of each of the external electrodes 63 is not limited to the shape of a cylinder, but the shape may be a shape of a cylinder whose cross-section is in an approximate shape of character C, or a shape of a cap that covers each of the ends of the glass bulb 61.

A protection film 64 and a phosphor layer 65 (tri-band phosphor, for example) are laminated on an inner surface of the glass bulb 61 in sequence. Also, mercury and a rare gas are enclosed in the glass bulb 61.

### INDUSTRIAL APPLICABILITY

The fluorescent lamp of the present invention can be used for not only a cold-cathode fluorescent lamp but also general fluorescent lamps such as an external-electrode fluorescent lamp. Especially, the fluorescent lamp of the present invention is suitable for a curved cold-cathode fluorescent lamp that tends to have snaking. Also, the backlight unit of the present invention can be used for a liquid crystal display televisions and other liquid crystal display devices. Moreover, the manufacturing method of the fluorescent lamp of the present invention can be used for manufacturing a curved fluorescent lamp.

1. A fluorescent lamp including a curved glass bulb that has a layer including a phosphor layer on an inner surface, mercury and a rare gas enclosed inside, and a pair of electrodes at both ends, characterized in that:
a gas pressure in the glass bulb is in a range of 4.0 kPa to 13.4 kPa inclusive; and
when a tube inner diameter, expressed in mm, of the glass bulb is plotted on a horizontal axis of an orthogonal coordinate system and a total amount of CO₂ and CO, expressed in mol %, contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments AB, BC, CD, and DA that connect a point A (1.5 mm, 0.008 mol %), a point B (4.0 mm, 0.0005 mol %), a point C (4.0 mm, 0 mol %), and a point D (1.5 mm, 0 mol %) in the stated order.

2.-3. (canceled)

4. The fluorescent lamp of claim 1, wherein
a getter for trapping CO₂ and CO is provided in the glass bulb.

5.-7. (canceled)

8. The fluorescent lamp of claim 1, wherein
the layer including the phosphor layer further includes a protection film containing a low-melting glass.

9. The fluorescent lamp of claim 8, wherein
a getter for trapping CO₂ and CO is provided in the glass bulb.

10. A fluorescent lamp including a curved glass bulb that has a layer including a phosphor layer on an inner surface, mercury and a rare gas enclosed inside, and a pair of electrodes at both ends, characterized in that:
a gas pressure in the glass bulb is in a range of 4.0 kPa to 13.4 kPa inclusive; and
when a tube inner diameter, expressed in mm, of the glass bulb is plotted on a horizontal axis of an orthogonal coordinate system and a total amount of CO₂ and CO, expressed in mol %, contained in gas present inside the glass bulb is plotted on a vertical axis of the orthogonal coordinate system, the tube inner diameter and the total amount of CO₂ and CO are in a predetermined area or on a boundary thereof, the predetermined area being bounded by line segments EF, FG, GH, and HE that connect a point E (2.0 mm, 0.005 mol %), a point F (3.0 mm, 0.0015 mol %), a point G (3.0 mm, 0 mol %), and a point H (2.0 mm, 0 mol %) in the stated order.

11. The fluorescent lamp of claim 10, wherein
the layer including the phosphor layer further includes a protection film containing a low-melting glass.

12. The fluorescent lamp of claim 11, wherein
a getter for trapping CO₂ and CO is provided in the glass bulb.

13. The fluorescent lamp of claim 10, wherein
a getter for trapping CO2 and CO is provided in the glass bulb.

14. A backlight unit including the fluorescent lamp of claim 1 as a light source.

15. A backlight unit including the fluorescent lamp of claim 10 as a light source.

16. A backlight unit including the fluorescent lamp of claim 12 as a light source.

17. A manufacturing method of a curved fluorescent lamp, which forms a phosphor layer on an inner surface of a straight glass bulb, attaches a pair of electrodes to both ends of the glass bulb, encloses mercury and a rare gas in the glass bulb, and then bends the straight glass bulb into a curved shape, characterized in that:
after the bending, an aging process of eliminating CO2 and CO in the glass bulb is performed by passing a current exceeding a current value for steady lighting through the pair of electrodes.
